(19) United States
(12) Patent Application Publication
(10) Pub. No.: US 2015/0317366 A1
(43) Pub. Date: Nov. 5, 2015

(54) GENERATING VISUAL REPRESENTATIONS OF ATTRIBUTES OF SELECTED SETS OF MEMBERS OF A SOCIAL NETWORK

(71) Applicant: LinkedIn Corporation, Mountain View, CA (US)

(72) Inventor: Prasad Kamalakar Gune, Fremont, CA (US)

(21) Appl. No.: 14/578,270

(22) Filed: Dec. 19, 2014

Related U.S. Application Data
(60) Provisional application No. 61/986,637, filed on Apr. 30, 2014.

(51) Int. Cl. G06F 17/30; G06Q 10/10; H04L 29/08

(52) U.S. Cl. CPC G06F 17/30554; H04L 67/306; G06Q 10/1053

(57) ABSTRACT

Techniques for visually comparing a first talent pool to a second talent pool are described. A first set of profiles of members of a social network is identified. A second set of profiles of members of the social network is identified. A selection of an attribute in common between the first set of profiles and the second set of profiles is received. A set of visual representations comparing values specified in data fields of the first set of profiles is generated with respect to the attribute and values specified in data fields of the second set of profiles with respect to the attribute in common. The set of visual representations is communicated for presentation in a user interface.

### CROSS-REFERENCE TO RELATED APPLICATIONS

This application claims the benefit of U.S. Provisional Patent Application Ser. No. 61/986,637, filed Apr. 30, 2014, which is incorporated herein by reference in its entirety.

### TECHNICAL FIELD

This application relates generally to the technical field of online social networking, and, in one specific example, to providing job recruiters with visual representations of attributes of pools of potential job candidates based on an analysis of profiles of the potential job candidates maintained with respect to an online social networking system.

### BACKGROUND

Job recruiters may use various features of social networking systems to find potential candidates for job openings that the recruiter seeks to fill.

### BRIEF DESCRIPTION OF THE DRAWINGS

Some embodiments are illustrated by way of example and not limitation in the figures of the accompanying drawings in which:

FIG. 1 is a network diagram depicting an example client-server system within which various embodiments may be deployed;

FIG. 2A is a block diagram depicting example client module(s) that may implement various embodiments;

FIG. 2B is a block diagram illustrating example server module(s) that may implement various embodiments;

FIG. 3 is a flow chart illustrating example operations of a method of generating a set of visual representations of values corresponding to each of a set of attributes of a set of members of a social-networking system;

FIG. 4 is a flow chart illustrating example operations of a method of generating a set of visual representations comparing a first set of members of a social network to a second set of members of the social network with respect to a set of attributes;

FIG. 5 is a flow chart illustrating example operations of a method of generating a visual representation of a selected skill corresponding to a pool of potential targets based on a criterion;

FIG. 6 is a line drawing illustrating an example user interface for presenting a generated visual representation of selected attributes of a selected talent pool.

FIG. 7 is a line drawing illustrating another example user interface for presenting a generated visual representation of selected attributes of a selected talent pool; and

FIG. 8 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, to avoid obscuring the inventive concepts in unnecessary detail, well-known instruction instances, protocols, structures, and techniques have not been shown in detail. As used herein, the term “or” may be construed in an inclusive or exclusive sense, the term “user” may be construed to include a person or a machine, and the term “interface” may be construed to include an application program interface (API) or a user interface.

In various embodiments, a method is disclosed for communicating a set of visual representations of values corresponding to a set of attributes of a set of members of a social-networking system. A query is received from a user. A set of profiles of members of a social-networking system is identified based on the query. A set of attributes of the set of members is identified. A set of visual representations of values corresponding to each of the set of attributes is generated. The set of visual representations are communicated for presentation to the user.

In various embodiments, techniques for visually comparing a first talent pool to a second talent pool are described. A first set of profiles of members of a social network is identified. A second set of profiles of members of the social network is identified. A selection of an attribute in common between the first set of profiles and the second set of profiles is received. A set of visual representations comparing values specified in data fields of the first set of profiles is generated with respect to the attribute and values specified in data fields of the second set of profiles with respect to the attribute in common. The set of visual representations is communicated for presentation in a user interface.

These and other methods or embodiments disclosed herein may be implemented as a computer system having one or more modules (e.g., hardware modules or software modules). Such modules may be executed by one or more processors of the computer system. This method and other methods or embodiments disclosed herein may be embodied as instructions stored on a machine-readable medium that, when executed by one or more processors, cause the one or more processors to perform the instructions.

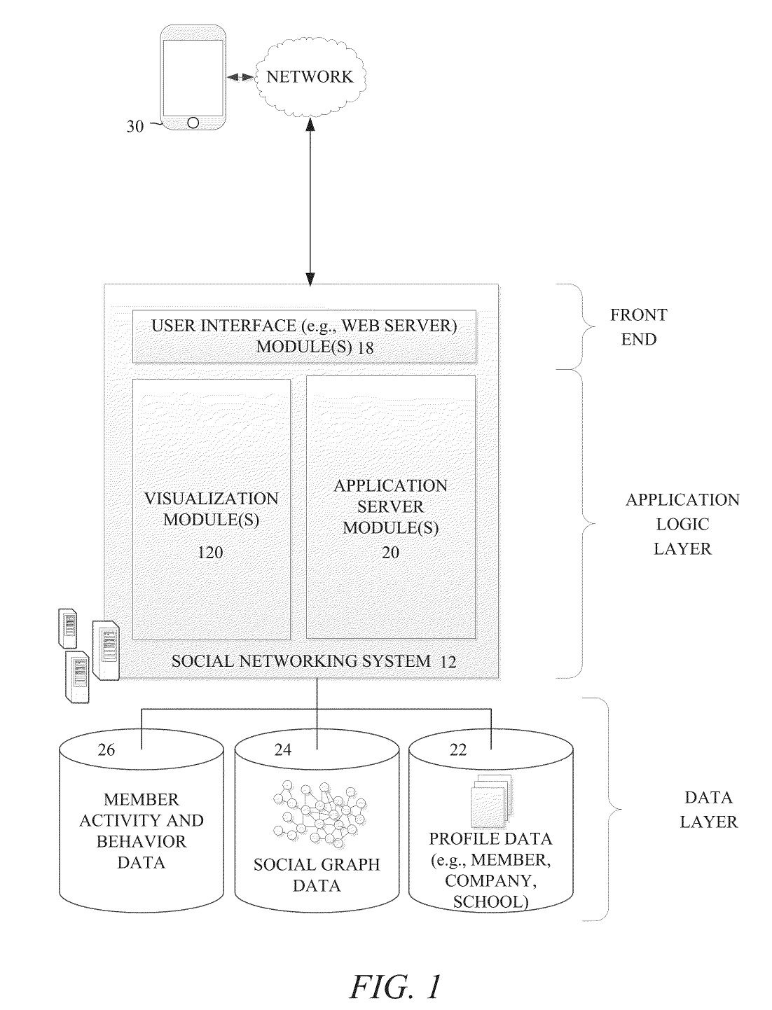

FIG. 1 is a network diagram depicting a server system (e.g., social networking system 12) that includes visualization module(s) 120 for responding to requests or commands received from a mobile computing device 30, consistent with some embodiments of the present invention. As described in greater detail below, the visualization module(s) 120 may be configured to receive commands or requests from devices, such as that with reference number 30 in FIG. 1, process or analyze the commands or requests, and transmit responses to the commands or requests. In various embodiments, the received commands or requests may include various information, such as a member identifier uniquely identifying a member of the social networking service (e.g., corresponding to a user of the mobile computing device 30), location information identifying a member's current location, and so on.

As shown in FIG. 1, the social networking system 12 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module (e.g., a web server) 18, which receives requests from various client-computing devices, such as one or more mobile computing devices 30, and communicates appropriate responses to the requesting client computing devices. For example, the user interface module(s) 18 may receive requests in the form of Hypertext Transport Protocol (HTTP) requests, or other web-based, application programming interface (API) requests. The client devices may be executing conventional web browser applications, or applications that have been developed for a specific platform to include any of a wide variety of mobile computing devices and mobile-specific operating systems.

As shown in FIG. 1, the data layer includes several databases, including a database 22 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database with reference number 22.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 12, information relating to the member's activity and behavior may be stored in a database, such as the database with reference number 26.

The social networking system 12 may provide a broad range of other applications and services that allow members the opportunity to share and receive information, often customized to the interests of the member. For example, with some embodiments, the social networking system 12 may include a photo sharing application that allows members to upload and share photos with other members. With some embodiments, members of a social networking system 12 may be able to self-organize into groups, or interest groups, organized around a subject matter or topic of interest. With some embodiments, members may subscribe to or join groups affiliated with one or more companies. For instance, with some embodiments, members of the social networking service 12 may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with the social graph data of the database with reference number 24.

The application logic layer includes various application server modules 20, which, in conjunction with the user interface module(s) 12, generates various user interfaces with data retrieved from various data sources or data services in the data layer. With some embodiments, individual application server modules 20 are used to implement the functionality associated with various applications, services and features of the social networking system. For instance, a messaging application, such as an email application, an instant messaging application, or some hybrid or variation of the two, may be implemented with one or more application server modules 20. A photo sharing application may be implemented with one or more application server modules 20. Similarly, a search engine enabling users to search for and browse member profiles may be implemented with one or more application server modules 20. Of course, other applications and services may be separately embodied in their own application server modules 20.

As illustrated in FIG. 1, social networking system 12 includes visualization module(s) 120, which are described in more detail below.

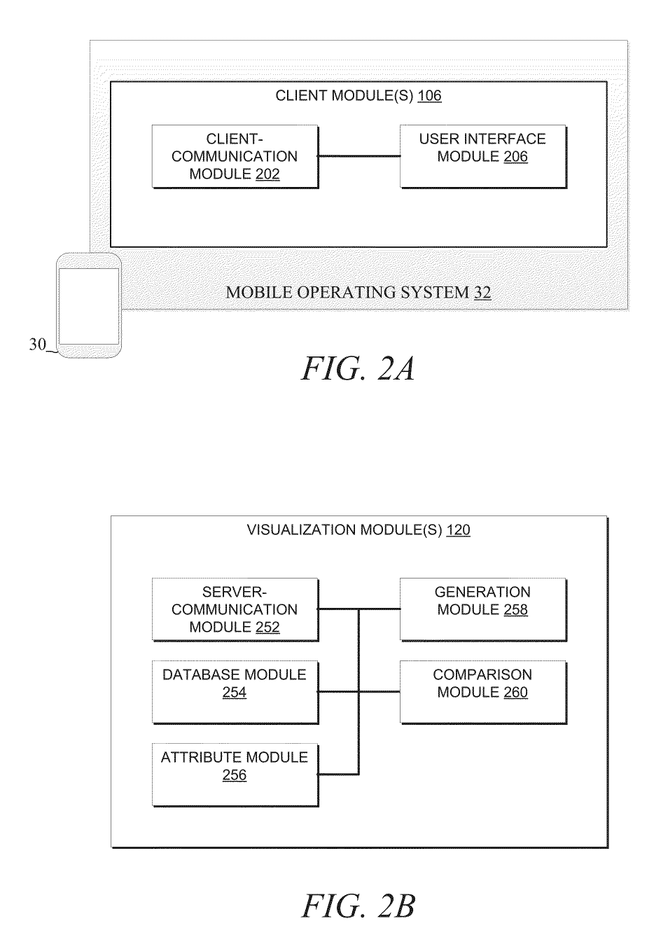

FIG. 2A is a block diagram depicting example client module(s) 106 of a mobile computing device 30, consistent with some embodiments of the invention. As is understood by skilled artisans in the relevant computer- and mobile device-related arts, each module or engine shown in FIG. 2A represents a set of executable software instructions and the corresponding hardware (e.g., memory, processor, sensor devices) for executing the instructions, and deriving or generating relevant data. To avoid obscuring the inventive subject matter with unnecessary detail, various functional modules and engines that are not germane to conveying an understanding of the inventive subject matter have been omitted from FIG. 2A.

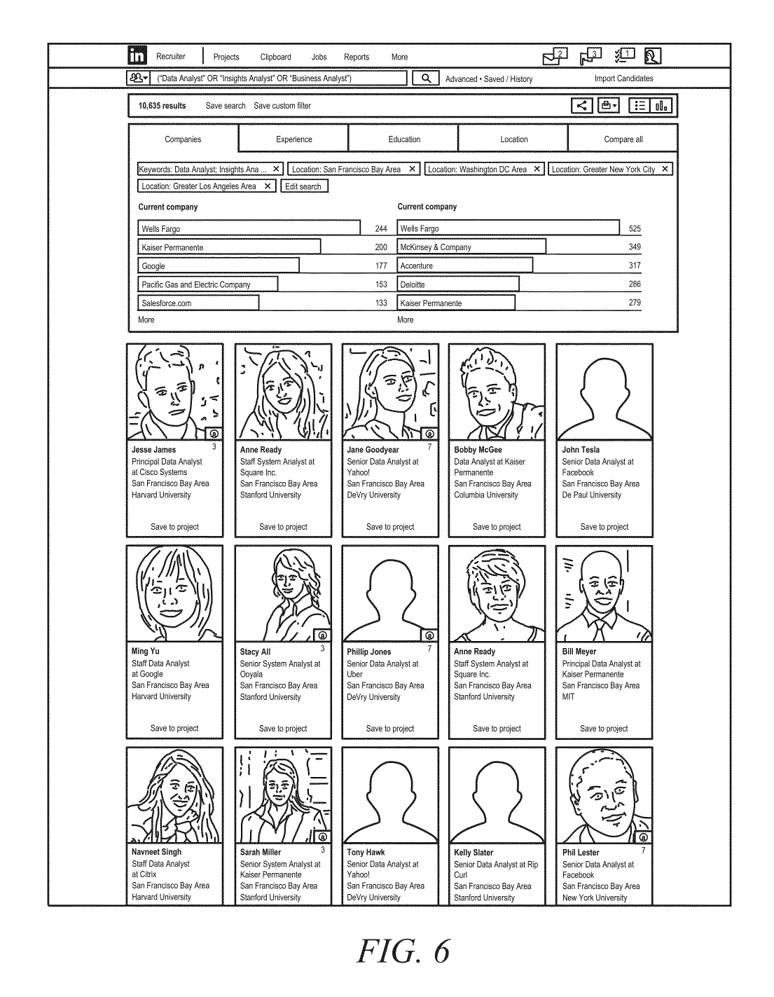

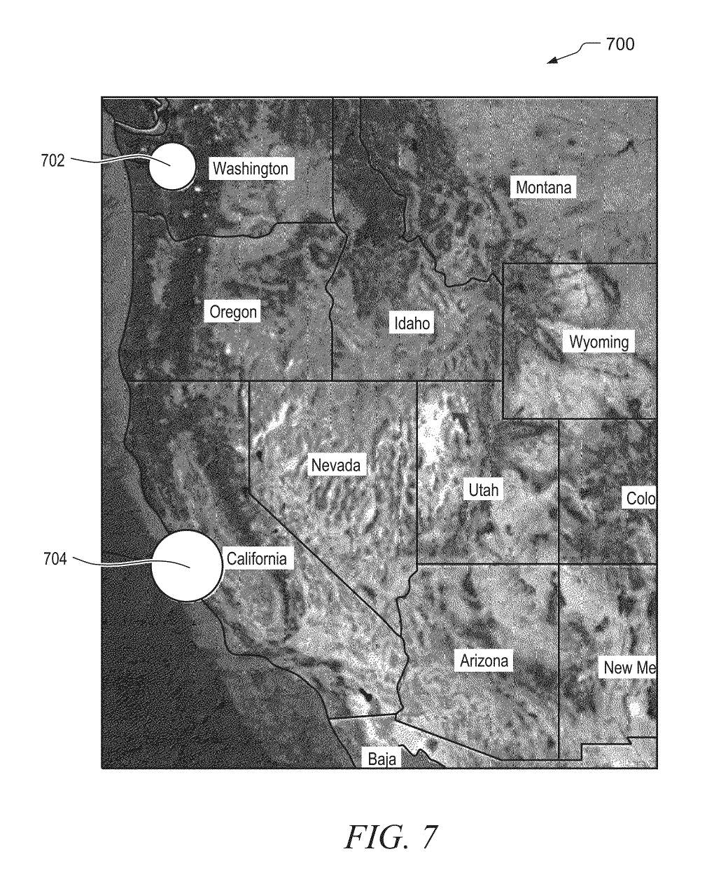

As illustrated in FIG. 2A, the mobile computing device 30 includes a mobile operating system 32. The client module(s) 106 include various modules 202-206. A client-communication module 202 may be configured to send communications (e.g., to the visualization module(s) 120) and may be configured to receive communications (e.g., from the visualization module(s) 120). A user interface module 206 may be configured to present a user interface to a user of the mobile computer device 30, such as one or more of the example user interfaces depicted in FIG. 6 and FIG. 7.

FIG. 2B is a block diagram illustrating example visualization module(s) 120. A server-communication module 252 may be configured to send and receive communications (e.g., to and from the mobile computing device 30).

A database module 254 may be configured to process queries to identify database records (e.g., user profiles) corresponding to the queries.

An attribute module 256 may be configured to identify attributes corresponding to a pool of identified database records, as will be described in more detail below.

A generation module 258 may be configured to generate visual representations of a selected set of attributes of a selected set of members of the social-networking system, as will be described in more detail below.

A comparison module 260 may be configured to compare a first set of members of the social-networking system with a second set of members of the social-networking system with respect to one or more attributes, as will be described in more detail below.

Although the functionality corresponding to the various modules is depicted and described as being implemented on one of the client side or the server side, in various embodiments, some or all of the functionality corresponding to modules may be implemented on either the client side, server side, or both. Thus, for example, in various embodiments, one or more algorithms implemented on the client side or server side may utilize information collected about the user on the client or server side, such as the member's current activity, current location, past behavior, social/graph data, profile data, and so on.

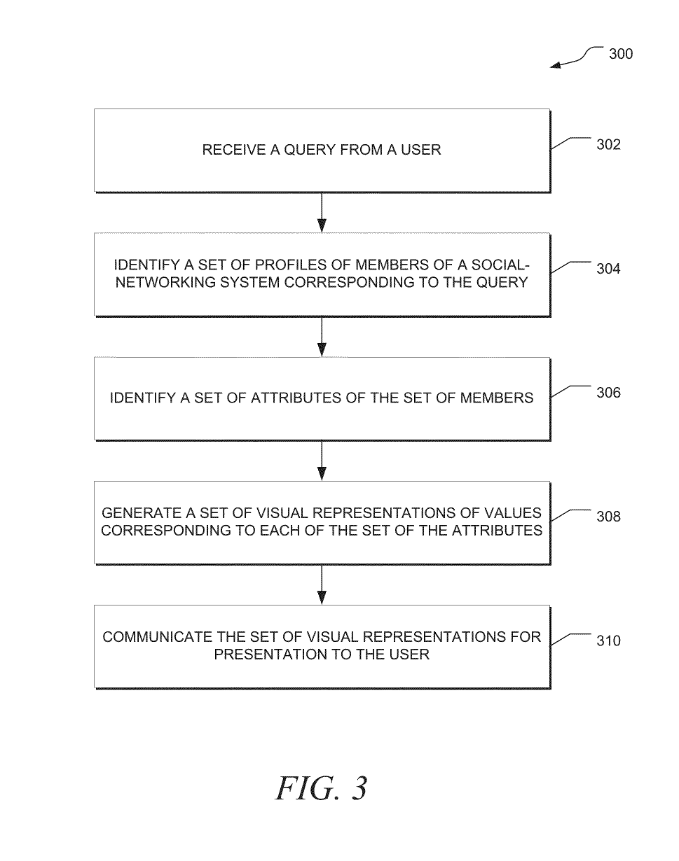

FIG. 3 is a flow chart illustrating example operations of a method 300 of generating a set of visual representations of values corresponding to each of a set of attributes of a set of members of a social-networking system. In various embodiments, the method 300 may be implemented by one or more of the modules of FIG. 2A or FIG. 2B.

At operation 302, the database module 254 may receive a query from a user (e.g., via the server communication module 252). For example, the user may enter one or more keywords in a search box of a user interface presented to the user on a device of the user. The keywords may then be communicated from the device to the query module. For example, a job recruiter seeking to fill a software engineering position may enter the keywords “software” and “engineer.” Or a job recruiter seeking to fill a position for which one of the job requirements is a particular skill, the job recruiter may enter keywords corresponding to the particular skill.

In various embodiments, the database module 254 may be configured to identify one or more predefined fields for which the user may specify one or more keywords or predefined values. For example, in the context of job recruiting, the field set may include fields such as country (e.g., of residence or place of employment), postal code (e.g., of residence or place of employment), radius (e.g., a geographical region having a radius extending from a location of residence to a place of employment), current job title, past job title, current company, past company, industry, first name, last name, years of experience, function, years in position, language (e.g., of proficiency), team activity, relationship (e.g., to user submitting query), seniority, years in company, groups (e.g., that the user has joined), status (e.g., of employment), school, degree, field of study, company followers, company type, company size, interested in (e.g., topics of interest), joined (e.g., date on which the target joined the social-networking system), and so on.

Thus, a user performing a search may submit a query that specifies keywords or predefined values corresponding to particular fields, such as queries including the phrases “years of experience=3,” “function=manager,” “degree=master of science in computer science,” and so on.

At operation 304, the database module 254 may identify a set of profiles of members of the social-networking system corresponding to the query. In various embodiments, the profiles of the members of the social-networking system may be maintained by the members of the social-networking system. In various embodiments, the information submitted by the members of the social-networking system may be structured based on a predetermined field set.

In various embodiments, the database module 254 may identify profiles corresponding to the query based on, for example, keywords specified by a first user (e.g., a job recruiter) in the query with keywords specified by a second user (e.g., a potential job candidate) in the profile of the second user. For example, a member who is currently employed as a software engineer may specify his current job title as “software engineer” in his profile. The database module 254 may then identify the user's profile as corresponding to a query based on the keywords “software” or “engineer” being specified in the query or the phrase “job title=software engineer” being included in the query.

At operation 306, the attribute module 256 may identify a set of attributes of the set of members. The set of attributes may be identified based on various factors, such as how relevant the attribute is to the user who submitted the query, how much data was provided by each of the members with respect to the attribute, and so on.

For example, a set of shared attributes may be identified based on a relevancy of the set of shared attributes to the user who submitted the query. The relevancy of the set of shared attributes to the user who submitted the query may be based on various additional factors, such as a context in which the query was submitted. For example, the attribute module 256 may identify that the user who submitted the query is a job recruiter who works for a particular company who is seeking to fill one or more particular job openings for which potential candidates must satisfy one or more job requirements. Based on this context information, the attribute module 256 may identify the relevant set of attributes as being attributes that correspond to the job requirements, to the company itself, or a combination of such attributes. For example, if the position that the recruiter intends to fill requires potential job candidates to have a particular degree, the attribute module 256 may include the degree attribute in the identified set of shared attributes.

In various embodiments, the attributes may be identified based on input from the user. For example, the user may specify (e.g., via a user interface), the attributes of the members corresponding to the search query for which the user seeks to view a visual representation.

At operation 308, the generation module 258 may generate a set of visual representations of the values corresponding to each of the identified set of shared attributes. Thus, as one example, if“degree” was included in the identified set of shared attributes, the generation module may generate a bar graph showing the names of the degrees obtained by each of potential job candidates matching the identified set of profiles.

At operation 310, the server-communication module 252 may communicate the set of visual representations for presentation to the user (e.g., via a user interface that is presented on a device of the user).

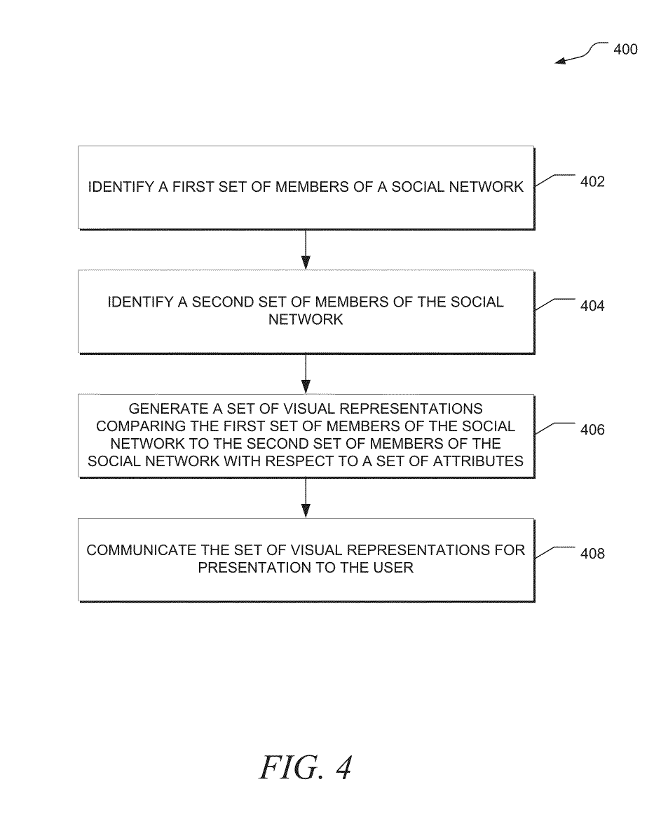

FIG. 4 is a flow chart illustrating example operations of a method 400 of generating a set of visual representations comparing a first set of members of a social network to a second set of members of the social network with respect to a set of attributes. In various embodiments, the method 400 may be implemented by one or more of the modules of FIG. 2A or FIG. 2B.

At operation 402, the database module 254 identifies a first set of members of a social network. In various embodiments, the identification of the first set of members of the social network may be based on a query submitted by a user. In various embodiments, the identification of the first set of members of the social network may be performed automatically based on a context of a request submitted by the user or based on information known about the user.

At operation 404, the database module 254 identifies a second set of members of the social network. In various embodiments, the identification of the second set of members of the social network may be based on an additional query submitted by the user. In various embodiments, the identification of the second set of members of the social network may be performed automatically based on a context of an additional request submitted by the user or based on the information known about the user.

At operation 406, the generation module 258 may generate a set of visual representations comparing the first set of members of the social network to the second set of members of the social network with respect to a set of attributes. In various embodiments, the set of attributes may be selected from a field set, such as the field set described above with respect to FIG. 3.

At operation 408, the server-communication module 252 may communicate the set of visual representations for presentation to the user.

As an example, consider a user who wishes to compare skills of people in a first talent pool (e.g., people employed by one or more organizations, living in a particular geographic area, actively seeking a new job, and so on) to skills of people in a second talent pool. In various embodiments, the user may activate the comparison by clicking on a user interface element presented to the user on a device of the user (e.g., by clicking on a button on a web page being presented to the user). In various embodiments, the user may specify one or more criteria for identifying the first talent pool (e.g., a query specifying a current employer, geographical location, and so on), one or more criteria for identifying the second talent pool or both.

In various embodiments, one or more of the talent pools that are to be compared may be automatically selected (e.g., based on a context in which the user submitted the request for the comparison) (e.g., by the comparison module 260). For example, if the user is an job recruiter employed by a first organization and activates the request for the comparison in a competitor context (e.g., by clicking on a “Compare Talent Pool of Competing Organizations” button within a user interface being presented to the user), the first talent pool may automatically be selected to be the first organization and the second talent pool may automatically be selected to include a set of organizations that are flagged as being competitors of the organization that employs the user.

Thus, in various embodiments, the user may be presented with visual representations of comparisons of one or more of fields pertaining to attributes of employees of each talent pool, such as a comparisons of degrees earned, years of experience, and so on. Thus, the user may be able to easily determine from the visual representation of the comparison of the values which talent pool has the greatest talent (e.g., with respect to particular attributes). For example, a visual representation may compare a percentage of individuals in each talent pool having particular degrees, advanced degrees, and so on. Or the visual representation may compare a percentage of individuals in each talent pool having graduated from Ivy League schools. Or the visual representation may compare a number of years of experience of individuals in each talent pool for particular job titles. In various embodiments, the set of attributes for which the comparison between the talent pools is performed may be selected manually or automatically as described above with respect to FIG. 3. Or the visual representation may overlay circles on a location on a map in which the radius of each circle represents a number or a concentration of people at that location having one or more skills (as specified in a query).

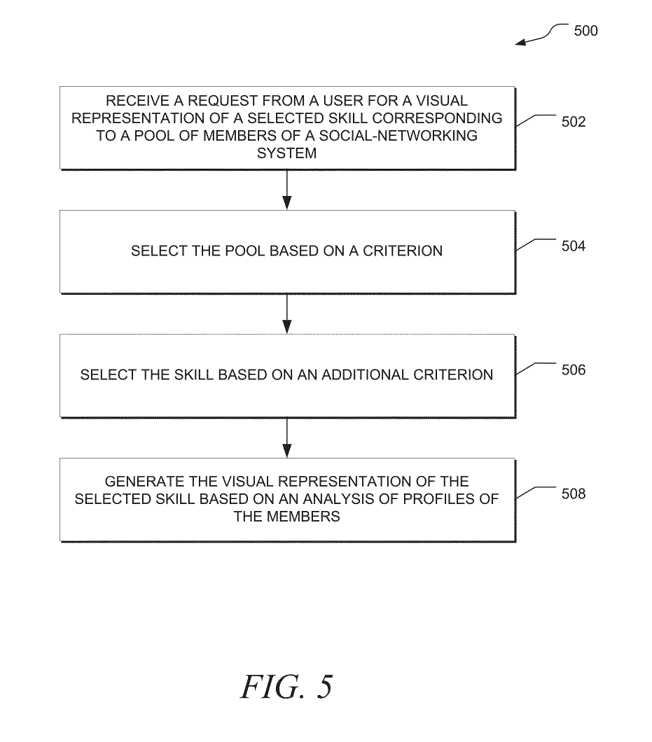

FIG. 5 is a flow chart illustrating example operations of a method 500 of generating a visual representation of a selected skill corresponding to a pool of potential targets based on a criterion. In various embodiments, the method 500 may be implemented by one or more of the modules of FIG. 2A or FIG. 2B.

At operation 502, the database module 254 receives a request from a user for a visual representation of a selected skill corresponding to a pool of members of a social-networking system.

At operation 504, the database module 254 selects the pool based on a criterion (e.g., as specified in a query submitted by the user). For example, the database module selects members of the social-networking system having a computer science degree based on the user submitted a query that includes the phrase “degree=BSCS.”

At operation 506, the attribute module 256 selects the skill based on an additional criterion. For example, the user may be presented with a list of general categories of skills of each of the members included in the pool, such as skills corresponding to the field sets described above with respect to FIG. 3. The user may then select one or more of the skills to request a visual representation of the breakdown of values for each skill within the talent pool.

At operation 508, the generation module 258 generates the visual representation of the selected skill of each of the members included in the pool based on an analysis of the profiles of the members. For example, if the user selects the “degree” skill, the visualization module may generate a bar graph showing a distribution of degrees earned by each of the members included in the pool. Thus, the generated bar graph may indicate the number of members in the pool having computer science degrees, electrical engineering degrees, mathematics degrees, physics degrees, and so on.

FIG. 6 is a line drawing illustrating an example user interface 600 for presenting a generated visual representation of selected attributes of a selected talent pool. Here, the members of the talent pool were previously selected (e.g., based on a query submitted by a user or an automatic selection based on a criterion, such as a context in which a request for the visual representation was submitted). Search results corresponding to the first talent pool and the second talent pool are filtered based on various criteria submitted by the user. For example, the search results may be filtered by particular keywords (e.g., (“Data Analyst” OR “Insights Analyst” OR “Business Analyst”)) or locations (e.g., “San Francisco Bay Area,” “Washington D.C. Area,” “Greater New York City Area,” “Greater Los Angeles Area”). Additionally, the attributes that are the subject of visual representation, such as companies (e.g., current employers), experience (e.g., length of employment within a career), and so on, may also have been previously selected (e.g., based on input from the user or an automatic selection). Here, the top five companies where the members of a first selected talent pool work are visually compared to the top five companies where the members of a second selected talent pool work. For example, each of the employers associated with each talent pool are represented in a vertical bar graph showing the percentage of members currently employed by each of the top five companies. In various embodiments, the graph corresponding to the first talent pool may be arranged from the employer with the most corresponding members to the least corresponding members, whereas the graph corresponding to the second talent pool may be arranged such that the names of the employers correspond to the names of employers in the first graph regardless of number of members employed. Additionally, although not shown in FIG. 6, additional graphs corresponding to each talent pool may be presented, such as graphs representing the number of years that each member has been employed at his current company. For example, additional graphs may be displayed in a horizontal bar graph showing the distribution of members with respect to the number of years.

In various embodiments, the values corresponding to the attributes of the member profiles in the first talent pool and the values corresponding to the attributes of the member profiles in the second talent pool are represented as selectable user interface elements. Upon a selection of the user interface element corresponding to an attribute, the value represented is included as a new filter of the search results. Each of the currently applied filters may be represented as additional user interface elements. Each of the currently applied filters may be removed by the user (e.g., by clicking the “X” to the right of the user interface element representing the applied filter). In various embodiments, a subset of the most popular values may be presented in the user interface, along with an option for the user to display additional values (e.g., by clicking on the “More” link).

In various embodiments, the search results include references to the profiles that satisfy the filtering criteria. The search results may be ranked by relevance, as described above. In various embodiments, each of the references in the search results may include a summary of values included in the profiles associated with the references. The summary may include, for example, a photo, name, title, current employer, location, university affiliation, and so on, specified in a profile of a member. In various embodiments, a user may access an expanded version of the profile, including additional profile data, by clicking on the reference.

In various embodiments, values corresponding to attributes may be organized under different pages within the user interface, such as pages corresponding to companies, experience, education, location, and so on. Additionally, in various embodiments, all of the values may be compared on a single page (e.g., a “Compare all” page).

As another example, the visual representation may include, for each talent pool, a vertical bar graph showing the distribution of relationships between the user who submitted the request and the members included in the pool, including how many members of the pool share a group with the user, have a shared connection with the user, worked at the same company as the user, and live in the same location as the user. The visual representation may also include a summary of an assessment of the personal relationships of the user, indicating that, in this particular case, 90% of the users in the pool have something in common with the user submitting the query.

FIG. 7 is a line drawing illustrating another example user interface 700 for presenting a generated visual representation of selected attributes of a selected talent pool. Here, the line drawing depicts relative sizes of each selected talent pool by a radius of a circle corresponding to a geographical area (e.g., Seattle, Wash. and San Jose, Calif.). For example, a talent pool identified based on the keywords “software engineer” may yield a visual representation showing the relative sizes or concentrations of individuals in the talent pool at geographical locations within a particular range (e.g., the western United States). Thus, a recruiter may be able to quickly identify geographical regions having small or large concentrations of members in the talent pool. The resolution of such a visual representation may be controllable by a user from within a user interface such that the user may zoom into smaller regions (e.g., states, counties, cities, neighborhoods) or zoom out to larger regions (e.g., countries, continents, and so on). Although not shown in FIG. 7, one or more additional talent pools may be presented in the visual representation (e.g., as additional circles having different colors). Thus, the visual representation may depict the differences (e.g., in size or concentration) between multiple talent pools (e.g., a talent pool matching the keywords “software engineer” and a talent pool matching the keywords “electrical engineer”).

In various embodiments, a user may compare the flow of talent from one company or organization to another company or organization. For example, a user may submit a query to show a number of employees who have listed a first company as a previous employer and a second company as a current employer. A visual representation may then be generated that includes a flow chart illustrating the movement of employees back and forth between the two companies. Additional nodes for additional companies or organizations may be included in the query and visual representation such that the flow of talent between organizations (e.g., of a particular industry) may be presented to the user. In this way, a recruiter may be able to better understand and take steps to reverse a negative trend with respect to movements of employees away from an organization that the recruiter represents.

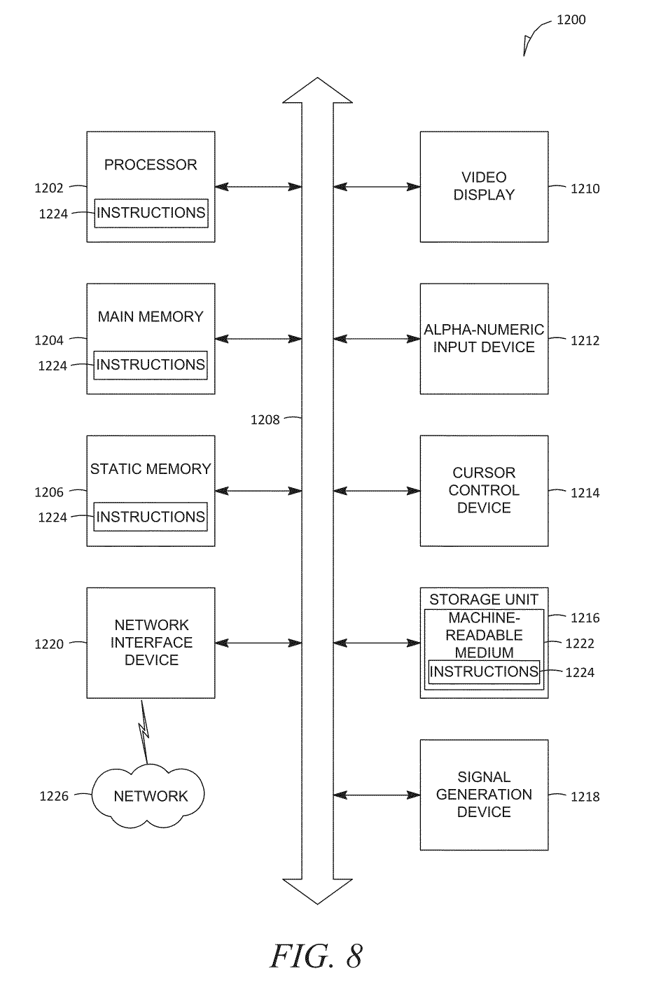

FIG. 8 is a block diagram of a machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a storage unit 1216, a signal generation device 1218 (e.g., a speaker) and a network interface device 1220.

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1224 may further be transmitted or received over a communications network 1226 using a transmission medium. The network 1226 may be one of the networks 1220. The instructions 1224 may be transmitted using the network interface device 1220 and any one of a number of well-known transfer protocols (e.g., Hyper Text Transfer Protocol (HTTP)). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
identifying a first set of profiles of members of a social network based on a matching of a first search query to values of data fields specified in the first set of profiles;
identifying a second set of profiles of members of the social network based on a matching of a second search query to values of data fields specified in the second set of profiles;
receiving a selection of an attribute in common between the first set of profiles and the second set of profiles;
generating a set of visual representations comparing values specified in data fields of the first set of profiles with respect to the attribute and values specified in data fields of the second set of profiles with respect to the attribute in common, the generating of the set of visual representations being performed by one or more computer processors; and
communicating the set of visual representations for presentation in a user interface.

2. The method of claim 1, wherein the selection of the attribute in common is from a set of attributes including at least two of companies, experience, education, and location.

3. The method of claim 1, further comprising filtering a set of search results based on a selection of a value corresponding to the attribute, the set of search results including references to an aggregation of the first set of profiles and the second set of profiles.

4. The method of claim 3, wherein the user interface comprises selectable user interface elements corresponding to values specified in the first set of profiles and the second set of profiles with respect to the attribute.

5. The method of claim 4, wherein the selection of the value is based on a notification that a user selected one of the selectable user interface elements corresponding to the value.

6. The method of claim 4, wherein the values specified in the first set of profiles are visually arranged according to the popularity of the values in the first set of profiles with respect to the attribute and the values specified in the second set of profiles are visually aligned with the visual arrangement of the values in the first set of profiles.

7. The method of claim 3, wherein each of the references to the set of search results includes a summary of values of the attributes specified in each of the profiles corresponding to the search results.

8. A system comprising:
one or more computer processors;
one or more modules implemented by the one or more computer processors, the one or more modules configured to:
identifying a first set of profiles of members of a social network based on a matching of a first search query to values of data fields specified in the first set of profiles;
identifying a second set of profiles of members of the social network based on a matching of a second search query to values of data fields specified in the second set of profiles;
receiving a selection of an attribute in common between the first set of profiles and the second set of profiles;
generating a set of visual representations comparing values specified in data fields of the first set of profiles with respect to the attribute and values specified in data fields of the second set of profiles with respect to the attribute in common, the generating of the set of visual representations being performed by one or more computer processors; and
communicating the set of visual representations for presentation in a user interface.

9. The system of claim 8, wherein the selection of the attribute in common is from a set of attributes including at least two of companies, experience, education, and location.

10. The system of claim 9, further comprising filtering a set of search results based on a selection of a value corresponding to the attribute, the set of search results including references to an aggregation of the first set of profiles and the second set of profiles.

11. The system of claim 10, wherein the user interface comprises selectable user interface elements corresponding to values specified in the first set of profiles and the second set of profiles with respect to the attribute.

12. The system of claim 11, wherein the selection of the value is based on a notification that a user selected one of the selectable user interface elements corresponding to the value.

13. The system of claim 11, wherein the values specified in the first set of profiles are visually arranged according to the popularity of the values in the first set of profiles with respect to the attribute and the values specified in the second set of profiles are visually aligned with the visual arrangement of the values in the first set of profiles.

14. The system of claim 10, wherein each of the references to the set of search results includes a summary of values of the attributes specified in each of the profiles corresponding to the search results.

15. A non-transitory computer-readable storage medium storing instructions thereon, which, when executed by one or more processors, cause the one or more processors to perform operations, the operations comprising:
identifying a first set of profiles of members of a social network based on a matching of a first search query to values of data fields specified in the first set of profiles;
identifying a second set of profiles of members of the social network based on a matching of a second search query to values of data fields specified in the second set of profiles;
receiving a selection of an attribute in common between the first set of profiles and the second set of profiles;
generating a set of visual representations comparing values specified in data fields of the first set of profiles with respect to the attribute and values specified in data fields of the second set of profiles with respect to the attribute in common, the generating of the set of visual representations being performed by one or more computer processors; and
communicating the set of visual representations for presentation in a user interface.

16. The non-transitory computer-readable storage medium of claim 15, wherein the selection of the attribute in common is from a set of attributes including at least two of companies, experience, education, and location.

17. The non-transitory computer-readable storage medium of claim 15, further comprising filtering a set of search results based on a selection of a value corresponding to the attribute, the set of search results including references to an aggregation of the first set of profiles and the second set of profiles.

18. The non-transitory computer-readable storage medium of claim 17, wherein the user interface comprises selectable user interface elements corresponding to values specified in the first set of profiles and the second set of profiles with respect to the attribute.

19. The non-transitory computer-readable storage medium of claim 18, wherein the selection of the value is based on a notification that a user selected one of the selectable user interface elements corresponding to the value.

20. The non-transitory computer-readable storage medium of claim 18, wherein the values specified in the first set of profiles are visually arranged according to the popularity of the values in the first set of profiles with respect to the attribute and the values specified in the second set of profiles are visually aligned with the visual arrangement of the values in the first set of profiles.
